(19) United States
(12) Patent Application Publication
(10) Pub. No.: US 2002/0067961 A1
(43) Pub. Date: Jun. 6, 2002

(54) Cutting tool

(75) Inventor: Peter Yewman, Lugoff, SC (US)

Correspondence Address: HOWARD & HOWARD ATTORNEYS, P.C., THE PINEHURST OFFICE CENTER, SUITE #101, 39400 WOODWARD AVENUE, BLOOMFIELD HILLS, MI, 48304-5151, US

(73) Assignee: Cogsdill Tool Products, Inc.

(21) Appl. No.: 09/730,941

(22) Filed: Dec. 6, 2000

(51) Int. Cl. B23B 27/00; B23C 5/00

(52) U.S. Cl. 407/30; 407/37

(57) ABSTRACT

A cutting tool (1) comprises an elongate shank (2), one end (3) of which is adapted to be secured in a machine tool and the other end (4) of which constitutes a cutting head. A portion of the shank (2) intermediate its ends is provided with at least one adjustable screw device (9) comprising a screw (12) and a tapped bore (13), the screw (12) having a frusto-conical bearing surface (14) operable on a portion of the shank (2) to induce a bending moment (1A, 4A, 9A, 12A) on the shank (2), for eccentricity correction.

### FIELD OF THE INVENTION

This invention relates to a cutting tool particularly, though not exclusively, to a tool with a rotary cutting action resulting either from rotation of the tool, such as a reamer, or rotation of the workpiece.

### BACKGROUND OF THE INVENTION

Such cutting tools, typically for machining metal, require fixing in or to a spindle or chuck of a machine tool for powered rotation of the tool.

One industry-standard spindle employs side locking, where a radially movable screw clamp engages a recess in the shank. It is unavoidable however that with side locking the tool rotates eccentrically, with resultant loss of accuracy in the workpiece being machined. In the past this inaccuracy of side lock tooling systems has been accepted as unavoidable, and other measures have sometimes been necessary to negate the effect of eccentricity.

### OBJECT OF THE INVENTION

A basic object of the present invention is the provision, in a cutting tool of a simple means of correcting the effect of eccentric tool mounting.

### SUMMARY OF THE INVENTION

According to the present invention there is provided a cutting tool comprising a shank, one end of which is adapted to be secured in a machine tool and the other end of which constitutes a cutting head, characterised in that a portion of the shank intermediate its ends is provided with at least one adjustable screw device comprising a screw and a tapped bore, the screw having a frusto-conical bearing surface operable on a portion of the shank to induce a bending moment on the shank, for eccentricity correction.

### ADVANTAGES OF THE INVENTION

Once a rotary cutting tool has been secured in a machine tool, its eccentricity can be checked by industry-standard techniques to determine what screw device adjustment is necessary to induce a desired stress in a desired direction to produce a bending moment to negate the effect of the eccentricity, thereby ensuring that the effect of eccentricity is eliminated thus increasing the accuracy of workpiece machining, which is particularly advantageous where accuracy is paramount, such as in reaming operations.

### PREFERRED OR OPTIONAL FEATURES

The screw is rotatable about a radial axis.

One screw device is provided.

Two screw devices, located 180° apart, are provided.

Three screw devices, located 120° apart, are provided.

Four screw devices, located 90° apart, are provided.

The screw has a frusto-conical head.

The or each screw device comprises a parallel screw and a tapered, tapped bore.

The or each screw device comprises a tapered screw and a tapered, tapped bore.

With multiple screw devices these may either be located in the same plane, or at least some of the devices may be axially spaced along the shank, so as to minimise mechanical weakness due to the presence of the screw devices, in any one plane, or circumferential zone of the shank.

The or each tapped hole has a frusto-conical mouth on which mouth the frusto-conical bearing surface is adapted to bear.

The or each tapped hole emerges at a parallel sided slot cut into the external periphery of the shank such that for a tool with four screw devices, four slots are provided, with the frusto-conical bearing surface adapted to bear on a side of its slot.

The slot(s) is arcuate.

The slot(s) is tangential.

The or each tapped hole emerges at a grove that is either parallel sided walls or has mutually inclined side walls, with the screw device adapted to bear on the sidewall(s).

The groove is provided in an enlarged diameter portion of the shank.

The groove has a radiussed transition into its sidewalls.

The shank is a round, parallel shank.

The shank is solid for dry cutting operations.

The shank has a co-axial central bore for coolant/lubricant flow.

The shank has an enlarged diameter cutting head and an enlarged diameter clamping end.

The or each screw device is manually adjustable.

### BRIEF DESCRIPTION OF THE DRAWINGS

FIG. 1 is a side elevation of a first embodiment of cutting tool in the form of a reamer, in accordance with the invention.

FIG. 2 is a section on the line A-A of FIG. 1.

FIG. 3 is a view in the direction of arrow A of FIG. 2;

FIG. 4 corresponds to FIG. 1 but shows a second embodiment;

FIG. 5 is a section on the line V-V of FIG. 4;

FIG. 6 is a view in the direction of arrow B of FIG. 5;

FIG. 7 is a section on the line VII-VII of FIG. 4;

FIG. 8 is a view in the direction of arrow C of FIG. 7;

FIG. 9 corresponds to FIG. 1 but shows a third embodiment;

FIG. 10 is a section on the line X-X of FIG. 9;

FIG. 11 is a view in the direction of arrow D of FIG. 10;

FIG. 12 corresponds to FIG. 1 but shows a fourth embodiment;

FIG. 13 is a section on the line XIII-XIII of FIG. 12; and

FIG. 14 is a view of the direction of arrow E of FIG. 13.

FIG. 15 corresponds to FIGS. 1, 4, 9 and 12, but shows a fifth embodiment mounted in an industry-standard ISO side-lock tool holder;

FIG. 16 is an enlargement of the portion of FIG. 15 circled by the chain-dotted line; and

FIG. 17 corresponds to FIG. 15, but shows an industry-standard HSK shank.

### DETAILED DESCRIPTION OF THE DRAWINGS

In all embodiments, like parts or components are accorded like reference numerals.

A cutting tool in the form of a reamer 1 comprises a round, parallel shank 2 provided at one end with an enlarged head 3 of industry-standard profile, for clamping in or by an industry-standard spindle or chuck (not shown), and at the other end with an enlarged diameter cutting head 4. The cutting head 4, is provided, in known manner, with a replaceable and positionally adjustable reamer blade 5 eg of a carbide, and a plurality of axially extending, circumferential spaced-apart guide pads 6 adapted, in known manner, to engage the wall of the hole (not shown) to be reamed.

Also conventionally, the reamer 1 has an axis of rotation 7 and a co-axial central bore 8 for coolant/lubricant.

All the above is known or is conventional.

In accordance with the invention, the shank 2 is provided intermediate its ends, with at least one, and preferably four screw devices 9 spaced 900 apart, with two screw devices 9 in one plane 10, and two screw devices 9 in an adjacent plane 11, as can be readily appreciated from FIGS. 1, 4, 9 and 12.

Each screw device 7 comprises a screw 12 passing into a tapped bore 13, with the screwl2 having a frusto-conical bearing surface 14 adapted to engage a portion of the shank 2 and, depending on the extent of their being screwed radially inwardly or radially outwardly, exerting bending moments on the shank 2 as exemplified by arrows 1A, 4A, 9A and 12A in FIGS. 1, 4, 9 and 17 to counter the eccentricity inherent in most if not all tool clamping systems.

In the embodiment of FIGS. 1 to 3, 15 and 16, the tapped bores 13, are each provided with a frusto-conical mouth 15 adapted to be engaged by the bearing surface 14 of an associated screw 12.

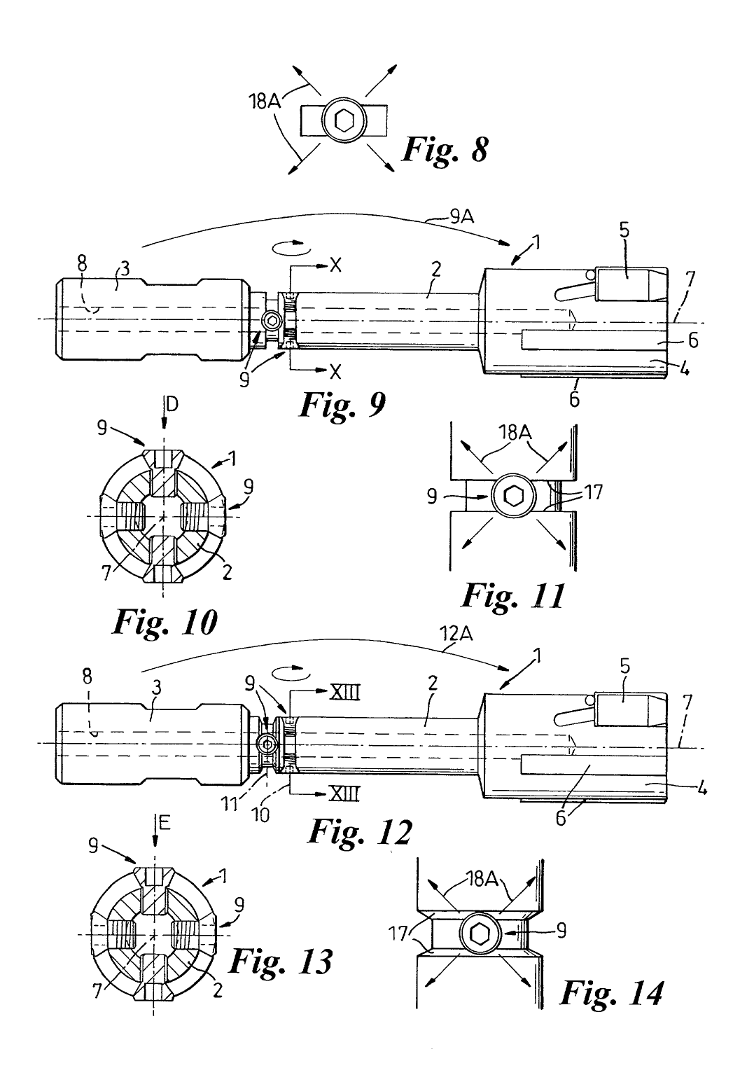

In the embodiments of FIGS. 4 to 8, the mouth 11 is extended transversely of the axis of rotation 7 by, in FIGS. 5 and 6 four arcuate slots 16 eg produced by a milling cutter, to define four pairs of spaced-apart sidewalls 17, with each pair engageable by the surface 14 of a screw 12, and in FIGS. 7 and 8 by four tangential slots 16A.

Instead of four slots 16 or 16A, FIGS. 10 to 14 indicated that the sidewalls 17 can extend over 360° by providing a circumferential groove 23 to define in FIGS. 10 and 11 parallel sidewalls 17, or in FIGS. 13 and 14, mutually inclined sidewalls 17.

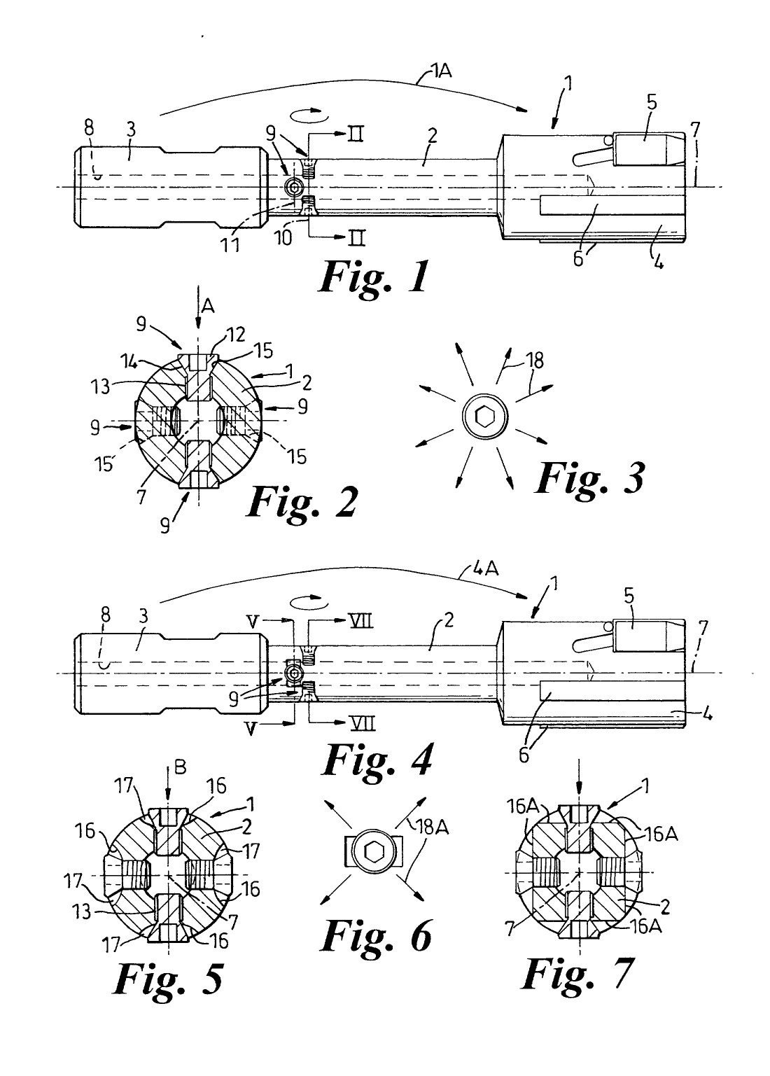

Arrows 18 in FIG. 3 indicate typical directions in which bending movements can be applied to the shank 2 to correct eccentricity. Arrows 18A in FIGS. 6, 8, 11 and 14 illustrate four directions for the slotted embodiment.

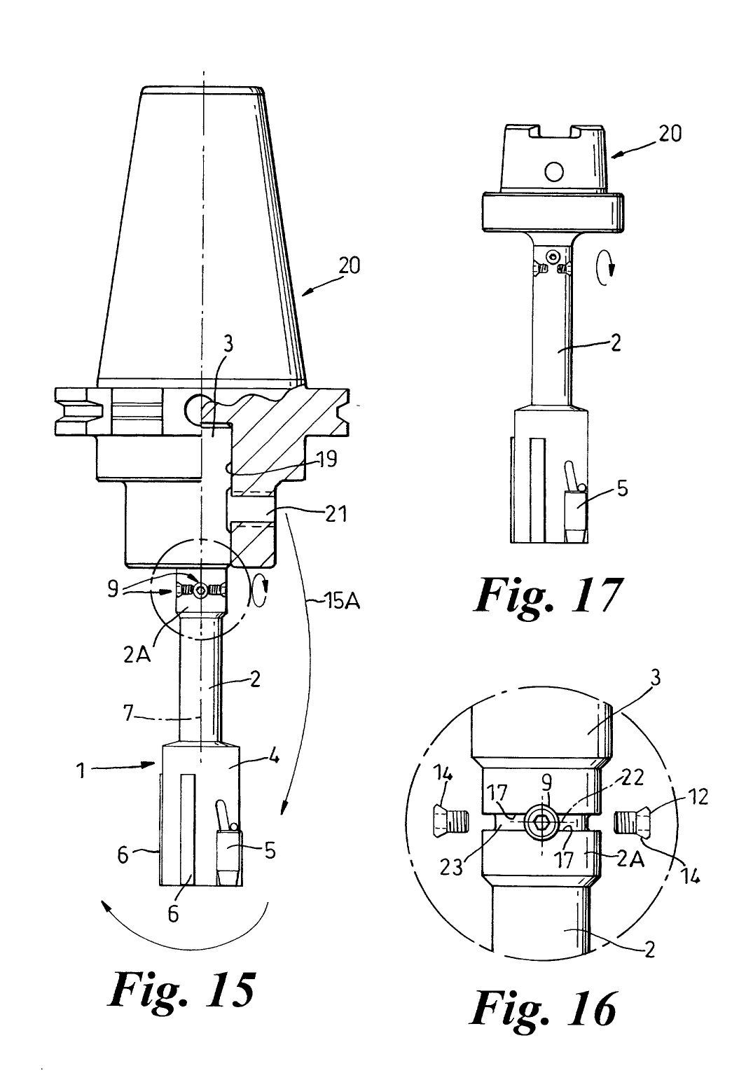

In FIGS. 15 and 16, the enlarged head 3 is shown fitted into a receiving socket 19 of an industry-standard side-lock tool holder 20, and secured by a clamping screw 21. In this preferred embodiment, four screw devices 9 are provided at 90° spacings in the same circumferential plane 22, and to compensate for the reduced strength resulting from four tapped bores 13, the shank is of an increased diameter over a portion 2A in which the four screw devices 9, and hence four tapped bores 12 are provided, in a groove 23 having a radiussed transition into sidewalls 17, as best seen in FIG. 16.

What I claim is:

1. A cutting tool comprising a shank having two ends, one of said ends being adapted to be secured in a machine tool and the other of said ends constituting a cutting head, characterised in that a portion of said shank intermediate its said ends is provided with at least one adjustable screw device comprising a screw and a tapped bore, said screw having a frusto-conical bearing surface operable on a portion of said shank to induce a bending moment on said shank, for eccentricity correction of said tool.

2. A cutting tool as claimed in claim 1, wherein said screw is rotatable about a radial axis.

3. A cutting tool as claimed in claim, 1, wherein one of said screw devices is provided.

4. A cutting tool as claimed in claim 1, wherein two of said screw devices, located 180° apart, are provided.

5. A cutting tool as claimed in claim 1, wherein three of said screw devices, located 120° apart, are provided.

6. A cutting tool as claimed in claim 1, wherein four of said screw devices, located 90° apart, are provided.

7. A cutting tool as claimed in claim 1, wherein the or each of said screws has a frusto-conical head.

8. A cutting tool as claimed in claim 1, wherein the or each of said screw devices comprises a parallel screw and a tapered, tapped bore.

9. A cutting tool as claimed in claim 1, wherein the or each of said screw devices comprises a tapered screw and a tapered, tapped bore.

10. A cutting tool as claimed in claim 4, wherein said multiple screw devices are located in the same plane.

11. A cutting tool as claimed in claim 5, wherein said multiple screw devices are located in the same plane.

12. A cutting tool as claimed in claim 6, wherein said multiple screw devices are located in the same plane.

13. A screw device as claimed in claim 4, wherein at least some of said screw devices are axially spaced along said shank.

14. A screw device as claimed in claim 5, wherein at least some of said screw devices are axially spaced along said shank.

15. A screw device as claimed in claim 6, wherein at least some of said screw devices are axially spaced along said shank.

16. A cutting tool as claimed in claim 1, wherein the or each of said tapped bores has a frusto-conical mouth on which mouth said frusto-conical bearing surface is adapted to bear.

17. A cutting tool as claimed in claim 1, wherein said shank has an external periphery, and the or each of said tapped bores emerges at a parallel sided slot cut into said external periphery of said shank such that for a tool with four screw devices, four slots are provided, with said frusto-conical bearing surfaces adapted to bear on a side of its slot.

18. A cutting tool as claimed in claim 7, wherein said slot(s) is arcuate.

19. A cutting tool as claimed in claim 7, wherein said slot(s) is tangential.

20. A cutting tool as claimed in claim 1, wherein the or each tapped bore emerges at a groove.

21. A cutting tool as claimed in claim 20, wherein said groove has parallel side walls.

22. A cutting tool as claimed in claim 20, wherein said groove has mutually inclined side walls.

23. A cutting tool as claimed in claim 20, wherein said groove is provided in an enlarged diameter portion of said shank.

24. A cutting tool as claimed in claim 20, wherein said groove has a radiussed transition into the sidewalls thereof.

25. A cutting tool as claimed in claim 1, wherein said shank is a round, parallel shank.

26. A cutting tool as claimed in claim 1, wherein said shank is solid for dry cutting operations.

27. A cutting tool as claimed in claim 1, wherein said shank has a coaxial central bore for coolant/lubricant flow.

28. A cutting tool as claimed in claim 1, wherein said shank has an enlarged diameter cutting head and an enlarged diameter clamping end.
